(19) United States
(12) Patent Application Publication
(10) Pub. No.: US 2021/0047184 A1
(43) Pub. Date: Feb. 18, 2021

(54) METHOD AND APPARATUS FOR EFFECTIVE PREPARATION OF TRIFLUOROAMINE OXIDE

(71) Applicants: KOREA RESEARCH INSTITUTE OF CHEMICAL TECHNOLOGY; SK-MATERIALS CO., LTD., Yeongju-si (KR)

(72) Inventors: Hong Suk Kang, Daejeon (KR); In Joon Park, Daejeon (KR); Soo Bok Lee, Daejeon (KR); Won Wook So, Daejeon (KR); Shin Hong Yook, Daejeon (KR); Eun-ho Sohn, Daejeon (KR); Beom Sik Kim, Daejeon (KR); Junghun Kwak, Yeongju-si (KR); Byunghyang Kwon, Yeongju-si (KR)

(73) Assignees: KOREA RESEARCH INSTITUTE OF CHEMICAL TECHNOLOGY, Daejeon (KR); SK-MATERIALS CO., LTD., Gyeongsangbuk-do (KR)

(21) Appl. No.: 16/624,735

(22) PCT Filed: May 31, 2019
(86) PCT No.: PCT/KR2019/006580

§ 371 Date: Dec. 19, 2019

(30) Foreign Application Priority Data
Nov. 23, 2018 (KR) 10-2018-0146346

(51) Int. Cl. C01B 21/084; B01J 10/00; B01J 19/00; B01D 3/10

(52) U.S. Cl. CPC C01B 21/0842; B01J 10/007; B01D 3/101; B01J 19/0066; B01D 3/106; B01J 19/0013

(57) ABSTRACT

The present invention relates to a preparation method of trifluoroamine oxide which comprises the steps of producing an intermediate product by reacting nitrogen trifluoride and nitrous oxide in the presence of a reaction catalyst wherein the unreacted gas containing nitrogen (N₂) produced in the course of the reaction is removed and instead nitrogen trifluoride and nitrous oxide are injected additionally; and producing trifluoroamine oxide by reacting the intermediate product with sodium fluoride.

### BACKGROUND OF THE INVENTION

### 1. Field of the Invention

The present invention relates to a method and an apparatus for effective preparation of trifluoroamine oxide.

### 2. Description of the Related Art

A thin film preparation process such as semiconductor manufacturing has been well known as CVD (Chemical Vapor Deposition) process. In the case of forming a thin film such as a semiconductor in a CVD chamber, it is preferred to form the thin film on a designated area or on a target subject in the CVD chamber, but the thin film forming material is unnecessarily deposited on other exposed surfaces in the CVD chamber. For example, the material can be deposited on an inner wall surface of a chamber, a product fixing jig and a pipe, etc. In addition, the accumulated materials other than the target can be short-circuited in the deposition process. Such short-circuited materials or particles can contaminate the target formed or the film formed on the surface of the target to be produced. These problems lower the quality of the deposition process and also reduce the overall yield of the product. Therefore, a cleaning process is performed to remove the unnecessary deposits deposited in the chamber with a proper period. Such a cleaning process in the CVD chamber can be performed manually or by using a cleaning gas.

In general, a CVD chamber cleaning gas needs to have some basic properties. A cleaning gas should be able to clean the CVD chamber quickly. A cleaning gas should not generate harmful substances. In addition, a cleaning gas should be environmentally friendly. Up to date, perfluorinated compounds such as CF₄, C₂F₆, SF₆ and nitrogen trifluoride have been widely used as cleaning gases or etching gases for the deposited film in semiconductor or electronic device manufacturing processes. In particular, nitrogen trifluoride (NF₃) has been used the largest amount as a cleaning gas world-widely.

Such perfluorinated substances are stable materials so that they can exist in the atmosphere for a very long time. Since the used waste gas contains such perfluorinated substances that are not decomposed after being used at a high concentration, it is necessary to process such waste gas below the allowable standard value and to discharge it to the atmosphere. In addition, these conventional perfluorinated substances are known to have very high global warming potential (GWP) values (ITH: 100 years, CO₂ based CF₄: 9,200, SF₆: 23,900, nitrogen trifluoride: 17,200). Such gases become a considerable burden in the environment. Therefore, it is highly requested to find an alternative gas having a low GWP value and appropriate for etching or cleaning process. Even if a cleaning or an etching gas itself is environmentally friendly, it can be decomposed during cleaning or etching process, and thereby it can be changed to harmful gas such as CF₄ or nitrogen trifluoride. Therefore, it is important that the gas do not remain in the atmosphere for a long time after being discharged.

Nitrogen trifluoride (NF₃) gas is one of 6 greenhouse gases. The usage of nitrogen trifluoride is top of all those gases, which reaches approximately 50,000 tons/year world-widely. Nitrogen trifluoride also displays a high global warming potential value. For these reasons, nitrogen trifluoride gas is recognized as the first candidate gas to be limited among global warming gases. On the other hand, nitrogen trifluoride gas is essentially used in cleaning process of semiconductor industry, which is the largest industry in Korea, and the production volume in Korean companies is the largest in the world. To implement the international treaty for reducing greenhouse gas emissions such as the Paris Agreement, and at the same time to continue the advancement of semiconductor industry in Korea, it is urgently requested to reduce the usage of nitrogen trifluoride gas and instead to develop an alternative material to replace nitrogen trifluoride.

Among the alternative gas candidates, trifluoroamine oxide (F₃NO) is a promising candidate to replace nitrogen trifluoride since it is easily decomposed in an aqueous solution and thus displays an extremely low GWP but shows good quality as a cleaning gas. F₃NO has a very high ‘F’ content that affects etching and cleaning performance. Unlike non-degradable PFC, HFC, nitrogen trifluoride and SF₆, F₃NO is easily decomposed in acid or alkali aqueous solution, so that the global warming potential thereof. is estimated close to 0. It is also expected that the energy consumption and environmental burden for the treatment of unreacted residual F₃NO will be small. When F₃NO is leaking, it is non-irritant. F₃NO displays similar properties to nitrogen trifluoride at room temperature. Therefore, F₃NO is considered to have a high chance of being used as an alternative gas in primary consideration.

The preparation method of trifluoroamine oxide (F₃NO), an alternative gas candidate, is known to be extremely limited.

Reference document 1 (US Patent Publication No. 2003-0143846 A1) discloses a gas composition comprising F₃NO as a technique relating to a gas composition for internal cleaning of a reactor and for etching a film of a silicon-containing compound. According to the preparation method of F₃NO disclosed in the document above, NF₂OSb₂F₁₁ salt was synthesized by reacting nitrogen trifluoride and nitrous oxide at 150° C. in the presence of SbF₅ catalyst, and then F₃NO was synthesized by pyrolyzing NF₂OSb₂F₁₁ at a high temperature (>200° C.). However, the yield for the raw materials nitrogen trifluoride and nitrous oxide was as low as 20% and the document did not even mention about the purity thereof. Considering SbF₅, another raw material used therein, the yield was also as low as about 33%. In the case of synthesizing F₃NO by using SbF₅/NF₃/N₂O system, the synthesis method has not been fully approved in the aspects of risk, yield and gas purity, etc, so that the commercialization thereof is still in doubt. In addition, when the intermediate product, NF₂O-salt, is produced using the same reaction through a batch type method, the reaction rate is so slow that it takes as long hours as at least 80 hours, so it is very difficult to commercialize thereof.

### SUMMARY OF THE INVENTION

In an aspect of the present invention, it is an object of the present invention to provide a preparation method of trifluoroamine oxide (F₃NO) with high yield and increased productivity by reducing reaction time significantly through periodic addition of the raw materials, nitrogen trifluoride and nitrous oxide, to the SbF₅/NF₃/N₂O reaction system.

In another aspect of the present invention, it is also an object of the present invention to provide an apparatus for preparing trifluoroamine oxide (F₃NO) with increased productivity by reducing reaction time significantly through periodic addition of the raw materials, nitrogen trifluoride and nitrous oxide, to the SbF₅/NF₃/N₂O reaction system and high yield and high purity by introducing a separation process using a distillation column.

To achieve the above objects, in an aspect of the present invention, the present invention provides a preparation method of trifluoroamine oxide comprising the following steps:

producing an intermediate product by reacting nitrogen trifluoride and nitrous oxide in the presence of a reaction catalyst wherein the unreacted gas containing nitrogen (N₂) produced in the course of the reaction is removed and instead nitrogen trifluoride and nitrous oxide are injected additionally; and

producing trifluoroamine oxide by reacting the intermediate product with sodium fluoride.

In another aspect of the present invention, the present invention provides an apparatus for preparing trifluoroamine oxide comprising:

a reactor to produce an intermediate product through the reaction between nitrogen trifluoride and nitrous oxide in the presence of a reaction catalyst;

a first compressor to collect and compress the reaction gas containing nitrogen (N₂) generated in the reactor;

a distillation column connected to the first compressor to remove nitrogen in the reaction gas; and

a second compressor located at the bottom of the distillation column to collect the nitrogen-depleted reaction gas and recycle the nitrogen-depleted reaction gas to the reactor.

In addition, in another aspect of the present invention, the present invention provides trifluoroamine oxide prepared by the preparation method above.

### ADVANTAGEOUS EFFECT

The preparation method of trifluoroamine oxide provided in an aspect of the present invention can increase productivity by greatly reducing reaction time and provide higher yield and purity than any method ever known so far by introducing a distillation process at the same time.

### BRIEF DESCRIPTION OF THE DRAWINGS

FIG. 1 is a schematic diagram illustrating the example of an apparatus for preparing trifluoroamine oxide according to an example of the present invention.

FIG. 2 is a graph illustrating the conversion rates of nitrogen trifluoride and nitrous oxide over the time in the process of preparing trifluoroamine oxide in Example 1 and in Comparative Example 1.

### DESCRIPTION OF THE PREFERRED EMBODIMENTS

Hereinafter, the present invention is described in detail.

In an aspect of the present invention, the present invention provides a preparation method of trifluoroamine oxide comprising the following steps:

producing an intermediate product by reacting nitrogen trifluoride and nitrous oxide in the presence of a reaction catalyst wherein the unreacted gas containing nitrogen (N₂) produced in the course of the reaction is removed and instead nitrogen trifluoride and nitrous oxide are injected additionally; and

producing trifluoroamine oxide by reacting the intermediate product with sodium fluoride.

Hereinafter, the preparation method of trifluoroamine oxide (F₃NO) provided in an aspect of the present invention is described in detail, step by step.

First, the preparation method of trifluoroamine oxide provided in an aspect of the present invention comprises a step of producing an intermediate product by reacting nitrogen trifluoride and nitrous oxide in the presence of a reaction catalyst wherein the unreacted gas containing nitrogen (N₂) produced in the course of the reaction is removed and instead nitrogen trifluoride and nitrous oxide are injected additionally.

The step of producing an intermediate product above is performed according to the following reaction formula 1 or reaction formula 2 or reaction formula 1 and reaction formula 2. The reaction catalyst herein can be SbF₅. Examples of reaction formulas using the reaction catalyst above are shown below.

NF₃+N₂O+SbF₅→NF₂OSbF₆+N₂ <Reaction Formula 1>

NF₃+N₂O+2SbF₅→NF₂OSb₂F₁₁+N₂ <Reaction Formula 2>

In the step of producing an intermediate product, the reaction of reaction formula 1 and reaction formula 2 proceeds, and the reaction rate becomes slower as the reaction progresses. Eventually, the reaction time is prolonged to at least 80 hours. To overcome the problem above, in the present invention, the unreacted gas containing nitrogen (N₂) generated in the step of producing an intermediate product as shown in reaction formula 1 and reaction formula 2 was removed and instead pure nitrogen trifluoride and nitrous oxide were injected additionally, and thus the reaction time could be reduced by at least 80% and preferably at least 85%, compared with the prior art, to 8 to 12 hours.

As an example, in the step of producing an intermediate product, the concentration of nitrogen produced by adding nitrogen trifluoride and nitrous oxide in the presence of a reaction catalyst and the concentrations of nitrogen trifluoride and nitrous oxide consumed in the reaction can be tracked. When the conversion rate of each raw material gas reaches 40% to 90%, the unreacted gas containing nitrogen is removed, and pure nitrogen trifluoride and nitrous oxide are injected.

The removal of the reaction gas containing nitrogen and the injection of the pure nitrogen trifluoride and nitrous oxide can be performed the conversion rate based on nitrogen trifluoride and/or nitrous oxide tracked during the reaction reaches 45% to 85%, preferably when it reaches 50%˜85%, more preferably 65%˜85%, 70%˜80%, and most preferably 50%˜70%. The tracking of the reaction conversion rate can be performed by gas chromatography TCD and 5% fluorocol/carbopack B column.

The removal of the reaction gas containing nitrogen and the injection of the pure nitrogen trifluoride and nitrous oxide above can be tracked by gas chromatography and can be performed until there is no further pressure change. Particularly, the removal of the reaction gas containing nitrogen and the injection of the pure nitrogen trifluoride and nitrous oxide can be performed 2-6 times repeatedly, preferably 3-5 times and more preferably 3-4 times repeatedly. If performed more than three times, the removal of the reaction gas containing nitrogen and the injection of the pure nitrogen trifluoride and nitrous oxide can be performed in the second trial when the conversion rate of nitrogen trifluoride and/or nitrous oxide, tracked down in the course of the reaction, reaches 20%˜45%, preferably 25%˜40% and more preferably 30%˜35%. In the third trial, the removal of the reaction gas containing nitrogen and the injection of the pure nitrogen trifluoride and nitrous oxide can be performed when the conversion rate of nitrogen trifluoride and/or nitrous oxide, tracked down in the course of the reaction, reaches 2%˜20%, preferably 3%˜10% and more preferably 3%˜6%.

In the step of producing an intermediate product, it is preferable to separate nitrogen trifluoride and nitrous oxide from the reaction gas containing nitrogen to be eliminated and reuse them. The reaction gas containing nitrogen produced in the course of the step of producing an intermediate product can be subjected to a distillation process to remove nitrogen, and the raw materials nitrogen trifluoride and nitrous oxide can be separated and recycled to be used in the reaction. The recycling can be performed when the conversion rate based on initial and residual SbF₅ is 40%˜95%, preferably 50%˜90%, more preferably 60%˜85%. The time taken for the conversion rate to reach the conversion rate above is only 2˜3 hours, so that the reaction time to accomplish the entire conversion rate of 100% can be within 10 hours.

As described above, in the step of producing an intermediate product, the generated N₂ is removed and instead pure nitrogen trifluoride and nitrous oxide or nitrogen trifluoride and nitrous oxide which have been separated from the reaction gas, are additionally added thereto, by which the reaction time can be dramatically reduced. In addition, the size of the reactor can be reduced approximately ⅛˜ 1/20 by the original reactor in order to produce an equal amount of trifluoroamine oxide, indicating the productivity can be improved.

At this time, in the step of producing an intermediate product, the reaction ratio of the reaction catalyst:nitrogen trifluoride nitrous oxide is preferably 2:1-10:1-10, more preferably 2:1-5:1-5, more preferably 2:2-5:2-5, and most preferably 2:3-5:3-5. The reaction ratio of the reaction catalyst:nitrogen trifluoride nitrous oxide is based on the molar ratio of 2:1:1, and the molar ratio of nitrogen trifluoride and nitrous oxide can be 1-10, respectively. If the reaction ratio of the reaction catalyst nitrogen trifluoride nitrous oxide is less than 2:1:1 (the ratio of nitrogen trifluoride and nitrous oxide is less than 1 molar ratio, respectively), the reaction catalyst such as unreacted SbF₅, which is highly hygroscopic and smokable, might remain and act as impurities in the reaction process of producing trifluoroamine oxide, and at the same time, it is very difficult to work due to generation of heat and fume during the pulverization process. If the reaction ratio is more than 2:10:10 (the ratio of nitrogen trifluoride and nitrous oxide is more than 10 molar ratio, respectively), the reaction pressure goes too high, resulting in the increase of reactor production costs and the risk of explosion during the reaction. So, the preferable molar ratio is 2:2:2 (reaction catalyst:nitrogen trifluoride:nitrous oxide), and more preferable ratio is 2:1.2:2. That is because when the intermediate product NF₂O-salt is produced, the reaction catalyst and nitrogen trifluoride (NF₃) form a primary salt by chlorination and then react with nitrous oxide (N₂O). So, it is preferred to add a little excessive amount of nitrous oxide (N₂O) which displays a relatively lower reactivity.

In the step of producing an intermediate product, the reaction is preferably performed at a temperature between 110° C. and 150° C., more preferably at a temperature between 120° C. and 150° C., and most preferably at a temperature between 130° C. and 150° C.

If the reaction temperature is lower than 110° C., which is similar to the melting point of the intermediate product NF₂O-salt, the solid NF₂O-salt is precipitated, so that stirring is difficult and absorption of nitrogen trifluoride and nitrous oxide in the gas phase is slowed, indicating that the reaction does not go smoothly. If the reaction temperature is higher than 150° C., the decomposition reaction is induced partially so that the raw materials nitrogen trifluoride and nitrous oxide might be regenerated or the byproducts such as NO and NO₂ might be generated, resulting in the decrease of yield. If the reaction temperature is too high, high pressure is applied to the reactor, and thereby vapor pressure of the raw materials nitrogen trifluoride and nitrous oxide also increases. Then, absorbency of the reaction catalyst existing in the liquid state is reduced as well, and thereby the production cost of the reactor goes high and the reaction rate is lowered.

The reaction of reaction formula 1 and reaction formula 2, which is the steps of producing an intermediate product proposed by the present inventors, is a gas-liquid phase reaction. That is, unlike the gas-gas reaction proposed by some prior researchers, the reaction of the invention is the gas-liquid phase reaction, wherein the intermediate catalyst SbF₅ in the liquid phase absorbs nitrogen trifluoride and nitrous oxide in the gas phase, leading to neutralization reaction. Therefore, the reaction temperature is preferably maintained at a temperature lower than the boiling point of SbF₅, 149.5° C., and it is important to maintain a minimum temperature at which stirring can be smoothly performed.

Further, in the step of producing an intermediate product, the reaction is performed in a suitable high-pressure reactor, preferably in a reactor comprising an anchor type stirring device in the size of half the inner diameter of the reactor. The absorption of nitrogen trifluoride and nitrous oxide is promoted through the reactor and the stirring is maintained preferably at a rotation speed of 50 rpm to 800 rpm for progressing smooth reaction, more preferably at a rotation speed of 100 rpm to 500 rpm, and most preferably at a rotation speed of 200 rpm to 400 rpm. If the rotation speed is less than 50 rpm, the absorption of the gaseous materials nitrogen trifluoride and nitrous oxide becomes too slow in the course of the gas-liquid phase reaction, and thereby the reaction progress goes slow, suggesting that the reactor size needs to be increased and the productivity is decreased. If the rotation speed exceeds 800 rpm, mechanical abrasion due to high-speed stirring may occur, resulting in the increase of maintenance costs.

The type of the stirrer can be exemplified by a grand seal, a mechanical seal and a magnetic drive. However, considering the reaction above is a high temperature high pressure reaction, a magnetic drive is more preferred. The material of the reactor used in the reaction can be stainless steel, hastelloy or alloy. When stainless steel is used for the reactor, it is preferred to perform passivation using F₂ gas before use.

In the step of producing an intermediate product, nitrogen trifluoride and nitrous oxide can be loaded at the same time in the presence of a reaction catalyst, or nitrogen trifluoride is loaded to the reactor first and then nitrous oxide is loaded thereto stepwise. On the other hand, if nitrous oxide is loaded first and then nitrogen trifluoride is loaded stepwise in the presence of a reaction catalyst, indicating the reaction takes too long and the yield is very low. If nitrogen trifluoride is loaded first and then nitrous oxide is added stepwise, the yield is low.

In the step of producing an intermediate product, the progress of the reaction can be calculated by tracing the consumed source gases nitrogen trifluoride (NF₃) and nitrous oxide (N₂O), and the resulting gas nitrogen (N₂) by gas chromatography. In general, calibration is performed with a standard gas before calculation.

Particularly, in the step of producing an intermediate product, a process of tracking and analyzing the proportion of nitrogen trifluoride and nitrous oxide consumed and the ratio of nitrogen generated by using at least one system selected from the group consisting of gas chromatography TCD, 5% fluorocol/carbopack B column and molecularsieve capillary column during the reaction can be additionally included.

The preparation method of trifluoroamine oxide provided in an aspect of the present invention comprises a step of producing trifluoroamine oxide by reacting the intermediate product with sodium fluoride.

The step of producing trifluoroamine oxide (F₃NO) can be accomplished by the reactions of reaction formula 3 or reaction formula 4 or reaction formula 3 and reaction formula 4.

NF₂OSbF₆+NaF→F₃NO+NaSbF₆ <Reaction Formula 3>

NF₂OSb₂F₁₁+2NaF→F₃NO+2NaSbF₆ <Reaction Formula 4>

At this time, in the step of producing trifluoroamine oxide, the reaction ratio of the intermediate product and sodium fluoride is preferably in a molar ratio of 1:1-4. Particularly, the production of trifluoroamine oxide can be accomplished according to reaction formula 3 and reaction formula 4 above, and at this time the reaction is a solid-solid reaction. Therefore, the solid-solid surface contact is very important. In the reaction proposed in the present invention, the reaction molar ratio of the reaction product NF₂O-salt and sodium fluoride (NaF) is preferably 1.0-4.0 based on sodium fluoride. If the amount of sodium fluoride is less than 1.0 mol, the reaction might not be completed. On the other hand, if the amount of sodium fluoride is more than 4.0 mol, which means the amount of a solid material added thereto is increased, there might be a problem in stirring. To activate the solid-solid reaction, it is important to mix NF₂O-salt and NaF homogeneously. If sufficient contact is not accomplished due to unsatisfactory stirring, trifluoroamine oxide (F₃NO) is obtained only with a very low yield. To activate the contact between the reactants, NF₂O-salt and NaF are thoroughly pulverized and mixed before the reaction is induced, which can increase the yield. More preferably, the raw materials are mixed, followed by pellet molding, which leads to smooth reaction.

In the step of producing trifluoroamine oxide above, the reaction is preferably performed at a temperature range of 150° C. to 200° C., more preferably 170° C. to 190° C. and most preferably 180° C. to 190° C. If the reaction temperature is lower than 150° C., the reaction rate is very slow and the reactor size must be increased. If the reaction temperature is higher than 200° C., there is a high possibility of the generation of by-products. The possible by-products can be No and NO₂ which can be produced from the raw materials, and nitrogen trifluoride and nitrous oxide can be produced by the reversible reaction of the raw materials.

The final product F₃NO is not stable in such conditions of high temperature, high pressure and acidic atmosphere. Therefore, it is preferred to recover the product immediately after the generation. So, the pyrolysis reaction is preferably performed in vacuum condition in order to minimize the contact between the reaction product F₃NO and other compounds. The vacuum condition herein is preferably up to 100 mmHg, more preferably up to 10 mmHg or 1 mmHg˜100 mm Hg, and most preferably 1 mmHg˜10 mm Hg. If the pressure condition is out of the above range, both yield and purity would be lowered.

Further, in the step of producing trifluoroamine oxide, the progress of the reaction can be calculated by tracing the consumed raw material gases by gas chromatography. In general, calibration is performed with a standard gas before calculation.

Particularly, in the step of producing trifluoroamine oxide, a process of tracking and analyzing the ratio of the generated F₃NO and byproducts (nitrogen trifluoride, nitrous oxide and nitrogen) by using at least one system selected from the group consisting of gas chromatography TCD, 5% fluorocol/carbopack B column and molecularsieve capillary column during the reaction can be additionally included.

In another aspect of the present invention, the present invention provides an apparatus for preparing trifluoroamine oxide (100) comprising:

a reactor (10) to produce an intermediate product through the reaction between nitrogen trifluoride and nitrous oxide in the presence of a reaction catalyst;

a first compressor (20) to collect and compress the reaction gas containing nitrogen (N₂) generated in the reactor;

a distillation column (30) connected to the first compressor to remove nitrogen in the reaction gas; and

a second compressor (40) located at the bottom of the distillation column to collect the nitrogen-depleted reaction gas and recycle the nitrogen-depleted reaction gas to the reactor.

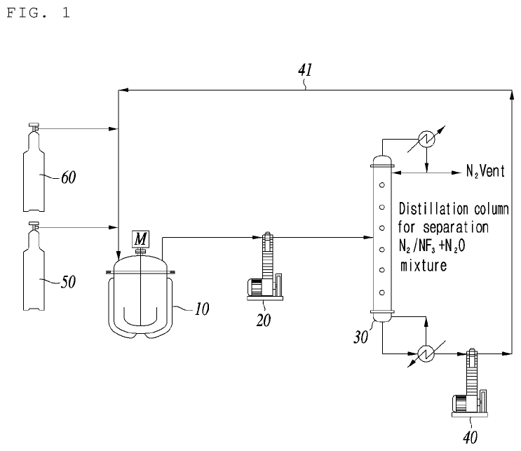

At this time, an example of the apparatus for preparing trifluoroamine oxide (100) provided in a preferred embodiment of the present invention is presented in FIG. 1.

Hereinafter, the apparatus for preparing trifluoroamine oxide (100) provided in a preferred embodiment of the present invention is described in more detail with reference to the schematic diagram of FIG. 1.

The apparatus for preparing trifluoroamine oxide (100) according to an example of the present invention is a device where the raw materials nitrogen trifluoride and nitrous oxide are loaded periodically for the reaction accomplished by reaction formula 1 and reaction formula 2 to prepare trifluoroamine oxide.

The apparatus for preparing trifluoroamine oxide (100) comprises a reactor (10) wherein an intermediate product can be prepared by reaction of nitrogen trifluoride and nitrous oxide in the presence of a reaction catalyst.

The reactor (10) can be a proper high pressure reactor generally used in the art, preferably a reactor comprising an anchor type stirrer, which is half the size of the inner diameter of the reactor. The type of the stirrer can be exemplified by a grand seal, a mechanical seal and a magnetic drive. However, considering the reaction for producing an intermediate product in the course of preparing trifluoroamine oxide is a high temperature high pressure reaction, a magnetic drive is more preferred. The material of the reactor can be stainless steel, hastelloy or alloy.

The apparatus for preparing trifluoroamine oxide (100) comprises a first compressor (20), a distillation column (30) and a second compressor (40), wherein the first compressor is to collect and compress the reaction gas containing nitrogen (N₂) generated in the reactor (10), the distillation column is connected to the first compressor and is to eliminate nitrogen from the reaction gas, and the second compressor is installed in the bottom of the distillation column to collect the nitrogen-depleted reaction gas and recycle the nitrogen-depleted reaction gas to the reactor. The nitrogen-depleted reaction gas can contain nitrogen trifluoride and nitrous oxide.

In the apparatus for preparing trifluoroamine oxide (100), a process of recycling nitrogen trifluoride and nitrous oxide can be performed through the first compressor (20) connected to the reactor (10), the distillation column (30) connected to the first compressor, and the second compressor (40) connected to the bottom of the distillation column. The second compressor can include a recycling line (41) for supplying nitrogen trifluoride and nitrous oxide to the reactor.

The apparatus for preparing trifluoroamine oxide (100) comprises a first supply unit (50) for supplying trifluoroamine oxide to the reactor (10); and a second supply unit (60) for supplying nitrous oxide to the reactor. The first supply unit and the second supply unit are connected to the recycling line (41) to supply the raw materials to the reactor.

In the case of preparing trifluoroamine oxide using the apparatus for preparing trifluoroamine oxide (100) above, trifluoroamine oxide (F₃NO) with increased productivity by reducing reaction time significantly through periodic addition of the raw materials, nitrogen trifluoride and nitrous oxide, to the SbF₅/NF₃/N₂O reaction system and high yield and high purity by introducing a separation process using a distillation column can be prepared.

In addition, in another aspect of the present invention, the present invention provides trifluoroamine oxide prepared by the preparation method above.

The trifluoroamine oxide according to the present invention has excellent purity, so that it can be used commercially.

Practical and presently preferred embodiments of the present invention are illustrative as shown in the following Examples.

However, it will be appreciated that those skilled in the art, on consideration of this disclosure, may make modifications and improvements within the spirit and scope of the present invention.

### EXAMPLE 1

Step 1: 200 g (0.92 gmol) of antimony pentafluoride (SbF₅) was placed in a stainless steel 1 L high pressure reactor equipped with a magnetic drive, an anchor type stirrer and a jacket and passivated with F₂ gas inside. 130.6 g (1.84 gmol) of nitrogen trifluoride (NF₃) and 80.96 g (1.84 gmol) of nitrous oxide (N₂O) were added thereto through MFC, and the reactor was tightly sealed. The stirring speed was maintained at 200 rpm and the reaction temperature was raised to 150° C.

The progress of the reaction such as reaction conversion rate was monitored by tracking N₂ generated and nitrogen trifluoride and nitrous oxide consumed in the reaction by using gas chromatography TCD and 5% fluorocol/carbopack B column. When the average conversion rate of antimony pentafluoride based on nitrogen trifluoride and nitrous oxide reached 70% 80%, the reaction gas N₂/NF₃/N₂O was removed and pure nitrogen trifluoride and nitrous oxide were injected therein. Gas discharge and new pure gas injection were tracked by gas chromatography and repeated 3-4 times until no further pressure change was observed. The final conversion rate was 106% based on SbF₅, and the total reaction time was 8.5 hours. The prepared reaction product, N₂FO-salt, was 225.7 g, and the reaction yield based on the reaction presented by reaction formula 2 was 94% by the reaction catalyst SbF₅.

The reaction gas (or waste gas) recovered from the NF₂—O salt reaction of step 1 was composed of 32% of N₂, 67% of nitrogen trifluoride and nitrous oxide, and 1% of other impurities. The recovered reaction gas was treated in the distillation column with a number of columns of 40, a top temperature of −50° C., and a distillation column operating pressure of 15 atm under the condition of total reflux, and thereby N₂ produced in the course of the reaction was eliminated in the upper part and nitrogen trifluoride and nitrous oxide were collected with 99% purity in the bottom part for recycling.

Step 2: The reactor used in step 1 above was disassembled and opened to recover the reaction product NF₂O-salt. The reaction product was mixed with 154.5 g (3.68 gmol) of sodium fluoride (NaF) and pulverized, which was loaded in the reactor. After sealing, the entire system including a condenser connected to the reactor was evacuated to 10 mmHg or less, followed by sealing again. The temperature was raised to 180° C., followed by pyrolyzing for 24 hours. As a result, trifluoroamine oxide (F₃NO) was obtained.

The produced F₃NO and the byproducts nitrogen trifluoride, nitrous oxide and nitrogen monoxide gas were analyzed by using gas chromatography TCD, 5% fluorocol/carbopack B column and molecularsieve capillary column. The volume and pressure of the recovered vessel were measured, and the final yield based on the reaction catalyst SbF₅ was 65.23%. The reaction results were analyzed by gas chromatography. The purity was over 94%.

### Comparative Example 1

Step 1: 200 g (0.92 gmol) of antimony pentafluoride (SbF₅) was placed in a stainless steel 1 L high pressure reactor equipped with a magnetic drive, an anchor type stirrer and a jacket and passivated with F₂ gas inside, to which 130.6 g (1.84 gmol) of nitrogen trifluoride (NF₃) was added through MFC. 80.96 g (1.84 gmol) of nitrous oxide (N₂O) was added thereafter, and the reactor was sealed. The stirring speed was maintained at 200 rpm and the reaction temperature was raised to 150° C.

The progress of the reaction such as reaction conversion rate was monitored by tracking N₂ generated and nitrogen trifluoride and nitrous oxide consumed in the reaction by using gas chromatography TCD and 5% fluorocol/carbopack B column. The total reaction time was 100 hours, and the final conversion rate was 104% based on nitrogen trifluoride and 106% based on nitrous oxide. The consumed gas and the generated gas (N₂) in the course of the reaction were the same materials as expected, confirmed by MS. The amount of the produced reaction product N₂FO-salt was 220.9 g and thus the reaction yield based on the reaction presented by reaction formula 2 was 92% by the reaction catalyst SbF₅.

Step 2: The reactor used in step 1 above was disassembled and opened to recover the reaction product NF₂O-salt. The reaction product was mixed with 154.5 g (3.68 gmol) of sodium fluoride (NaF) and pulverized, which was loaded in the reactor. After sealing, the entire system including a condenser connected to the reactor was evacuated to 10 mmHg or less, followed by sealing again. The temperature was raised to 180° C., followed by pyrolyzing for 24 hours. As a result, trifluoroamine oxide (F₃NO) was obtained.

The produced F₃NO and the byproducts nitrogen trifluoride, nitrous oxide and nitrogen monoxide gas were analyzed by using gas chromatography TCD, 5% fluorocol/carbopack B column and molecularsieve capillary column. The volume and pressure of the recovered vessel were measured, and the final yield based on the reaction catalyst SbF₅ was 60.56%. The reaction results were analyzed by gas chromatography. The purity was over 94%.

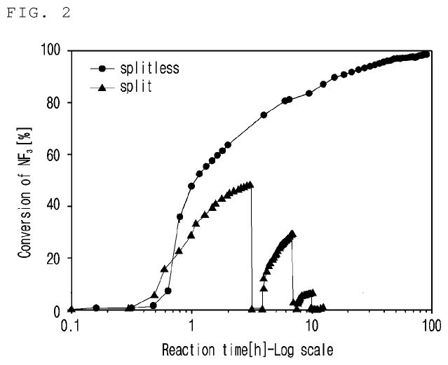

FIG. 2 is a graph illustrating the conversion rates of nitrogen trifluoride and nitrous oxide over the time in the process of preparing trifluoroamine oxide in Example 1 and in Comparative Example 1. The definition of the conversion rate of nitrogen trifluoride in FIG. 2 is as follows:

NF₃Conversion [%]=(NF₃ mol reacted/NF₃ mol unreacted+N₂ mol produced)*100

The present inventors tried to shorten the reaction time by split injection of the raw material gas. The raw material gas was supplied half the volume of the traditional supply and instead the amount was split and supplied stepwise 3-4 times. Then, the reaction was tracked until the reaction was terminated. As a result, a dramatic reduction of the reaction time was achieved. The reaction was maintained 3 hours after the first injection of the raw material and then the valve was opened to discharge the unreacted gas and the generated gas. The termination of the reaction through the repeat of injection/discharging was confirmed after the fourth injection, which was 12 hours after the reaction began. So, the reaction time was reduced 88% by the traditional reaction time (100%). The raw materials were used more but they were supposed to be recycled in the purification/separation process so that it was not a big problem.

Thus, it was confirmed that the method for preparing trifluoroamine oxide provided in an aspect of the present invention showed higher yield and purity than any method ever known so far.

### BRIEF DESCRIPTION OF THE MARK OF DRAWINGS

100: apparatus for preparing trifluoroamine oxide

10: reactor

20: first compressor

30: distillation column

40: second compressor

41: recycling line

50: first supply unit

60: second supply unit

What is claimed is:

1. A preparation method of trifluoroamine oxide comprising the following steps:
producing an intermediate product by reacting nitrogen trifluoride and nitrous oxide in the presence of a reaction catalyst wherein the unreacted gas containing nitrogen (N₂) produced in the course of the reaction is removed and instead nitrogen trifluoride and nitrous oxide are injected additionally; and
producing trifluoroamine oxide by reacting the intermediate product with sodium fluoride.

2. The preparation method of trifluoroamine oxide according to claim 1, wherein the step of producing an intermediate product is characterized by reusing nitrogen trifluoride and nitrous oxide separated from the unreacted gas containing nitrogen to be removed.

3. The preparation method of trifluoroamine oxide according to claim 1, wherein the step of producing an intermediate product is characterized by the repeat of the reaction process composed of removing the unreacted gas containing nitrogen (N₂) generated during the reaction and additionally injecting nitrogen trifluoride and nitrous oxide instead.

4. The preparation method of trifluoroamine oxide according to claim 1, wherein the reaction in the step of producing an intermediate product is performed at a temperature range of 110° C.˜150° C.

5. The preparation method of trifluoroamine oxide according to claim 1, wherein the reaction in the step of producing an intermediate product is performed with stirring at a rotation speed of 50˜800 rpm.

6. The preparation method of trifluoroamine oxide according to claim 1, wherein the reaction in the step of producing an intermediate product is performed in vacuum condition up to 100 mmHg.

7. The preparation method of trifluoroamine oxide according to claim 1, wherein the reaction ratio of the intermediate product to sodium fluoride is in a molar ratio of 1:1-4 in the step of producing an intermediate product.

8. The preparation method of trifluoroamine oxide according to claim 1, wherein the reaction in the step of producing trifluoroamine oxide is performed at a temperature range of 150° C.˜200° C.

9. An apparatus for preparing trifluoroamine oxide comprising:
a reactor to produce an intermediate product through the reaction between nitrogen trifluoride and nitrous oxide in the presence of a reaction catalyst;
a first compressor to collect and compress the unreacted gas containing nitrogen (N₂) generated in the reactor;
a distillation column connected to the first compressor to remove nitrogen in the unreacted gas; and
a second compressor located at the bottom of the distillation column to collect the nitrogen-depleted unreacted gas and recycle the nitrogen-depleted unreacted gas to the reactor.

10. The apparatus for preparing trifluoroamine oxide according to claim 9, wherein the apparatus is composed of a first supply unit for supplying trifluoroamine oxide to the reactor; and a second supply unit for supplying nitrous oxide to the reactor.

11. The apparatus for preparing trifluoroamine oxide according to claim 9, wherein the nitrogen-depleted unreacted gas contains nitrogen trifluoride and nitrous oxide.
